(19) United States
(12) Patent Application Publication
(10) Pub. No.: US 2004/0017540 A1
(43) Pub. Date: Jan. 29, 2004

(54) Anti-fogging sport glasses

(75) Inventor: Pasquale Matera, Plainview, NY (US)

Correspondence Address: SCHNADER HARRISON SEGAL & LEWIS, LLP, 1600 MARKET STREET, SUITE 3600, PHILADELPHIA, PA, 19103

(73) Assignee: Native Eyewear, Inc.

(21) Appl. No.: 10/299,396

(22) Filed: Nov. 18, 2002

Related U.S. Application Data
(63) Continuation of application No. 29/164,514, filed on Jul. 24, 2002.
(63) Continuation of application No. 29/164,515, filed on Jul. 24, 2002.

(51) Int. Cl. G02C 11/08; G02C 1/08

(52) U.S. Cl. 351/91

(57) ABSTRACT

A pair of eyeglasses which resist fogging are disclosed. The glasses may be a rimless design or a fully framed design. In each case, the glasses have a right upper lens rim and a left upper lens rim. Left and right lenses, each having front and occular sides, are supported by left and right upper lens rims, respectively. A bridge interconnects the right upper lens rim with the left upper lens rim. Each lens rim defines a plurality of apertures, displaced 70-90° from a horizontal viewing angle passing through the approximate center of the lens, to allow passage of air at the occular surface of the lens to limit fogging. In some embodiments, the temple arms are provided with enhanced gripping distal portions. The left and right temples, each extending from an outboard side of respective lens rims, terminate in a distal portion having a subtle S-shape for engaging the mastoid of the wearer. Preferred embodiments are useful as sport-glasses, with or without corrective and/or colored lenses.

### FIELD OF THE INVENTION

This invention relates to eyewear. More particularly, the invention relates to sport-glasses. Most particularly, the invention relates to sport-glasses which resist fogging.

### BACKGROUND OF THE INVENTION

In today's society, sports enthusiasts, whether professional, amateur, or recreational, are very sophisticated. Even casual enthusiasts demand high-quality, high-performance products. In recent years, as much focus has been given to sporting accessories as the main sporting equipment. Clothing and eyewear have seen great advances and demand in recent years.

Sporting eyewear has evolved over the years from bulky, medically necessary optics stapped securely to the wearer's head into today's sleek, aerodynamic designs. These advances have made sporting eyewear common even among those who do not need corrective lenses. The new designs may even enhance performance, by protecting the eyes from wind, rain, debris, and other distractions, in addition to correcting vision and/or protecting the wearer from the sun.

Because of the demanding nature of sport and its participants, ever increasing levels of performance are required. During the evolution of the sport-glasses, from those early goggle-like designs to the aerodynamic spectacles of today, the lenses and frames have become closer fitting, nearly molding to the contours of the wearer's features. Generally, this has the advantages of providing enhanced aesthetics, improved aerodynamics, greater protection from debris and the elements, and decreased size and weight. With these tighter fitting designs, one notable problem arises—fogging.

The tight fit that leads to greater aerodynamics also leads to reduced airflow on the occular side of the lens. Behind the lens, air becomes stagnant, moist from perspiration, and hot from generated body heat. The heat, coupled with added moisture and other conditions, leads to fogging of the lens. Condensation in the form of fogging forms on the lens, since the outside of the lens, subject to rushing winds, is markedly cooler than the occular side.

Accordingly, it is desirable to have sport glasses which increase the airflow behind the lens without sacrificing performance.

In professional sports, fractions of a second can separate champions from amateurs. Thus, reduced weight and increased aerodynamics are vital to any design. In decades gone by, sport-glasses were held in place by bulky, uncomfortable, and weight-laden straps. Today's designs rely largely on friction and tension to hold the glasses in place. Improved designs are continually sought for increased comfort and performance.

### SUMMARY OF THE INVENTION

A pair of eyeglasses which resist fogging are disclosed. The glasses may be a rimless design or a fully framed design. In each case, the glasses have a right upper lens rim and a left upper lens rim. Left and right lenses, each having front and occular sides, are supported by left and right upper lens rims. A bridge interconnects the right upper lens rim with the left upper lens rim. Each lens rim defines a plurality of apertures, displaced 70-90° from a horizontal viewing angle passing through the approximate center of the lens, to allow passage of air at the occular surface of the lens to limit fogging. In some embodiments, the temple arms are provided with enhanced gripping distal portions. The left and right temples, each extending from an outboard side of respective lens rims, terminate in a distal portionhaving a subtle S-shape for engaging the mastoid of the wearer. Preferred embodiments are useful as sport-glasses, with or without corrective and/or colored lenses.

### BRIEF DESCRIPTION OF THE DRAWINGS

FIG. 1 is a perspective view of one embodiment of the sport glasses according to invention.

FIG. 2 is a front elevational view of one embodiment of the sport glasses according to invention.

FIG. 3 is a rear elevational view of one embodiment of the sport glasses according to invention.

FIG. 4 is a side elevational view of one embodiment of the sport glasses according to invention.

FIG. 5 is a top plan view of one embodiment of the sport glasses according to invention.

FIG. 6 is a bottom view of one embodiment of the sport glasses according to invention.

FIG. 7A-7C show explosion of an embodiment having removable lenses.

FIG. 8 is a side cross-sectional view of one embodiment of the sport glasses according to invention.

FIG. 9 is a perspective view of alternate embodiment of the sport glasses according to invention.

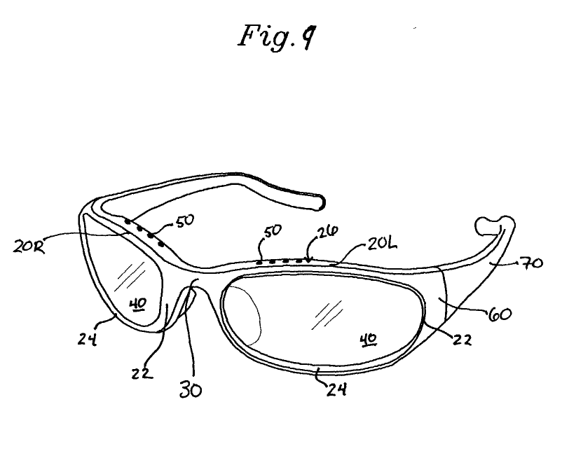

### DETAILED DESCRIPTION

Throughout this detailed description, reference is made to the drawing figures through reference numerals. Like reference numerals point out like elements throughout the figures. The description and the figures are illustrative only, and are not intended to limit the scope of the invention. Particularly, the inventor contemplates both framed and rimless varieties.

The sport-glasses 10, regardless of incarnation, include two upper lens rims 20R, 20L and an interconnecting bridge 30. The upper lens rims 20R, 20L are referred to from the wearer's point of view. Thus, the right lens rim refers to the lens rim corresponding to the wearer's right eye. Although in most applications, and as described herein, the left and right sides of the glasses are identical and symmetrical, it is well known in the art that modifications can be made to only one side of the glasses as needed to accommodate the wearer's particular features. With that in mind, this application presumes that the left-and right-hand sides of the glasses are substantially identical and symmetrical.

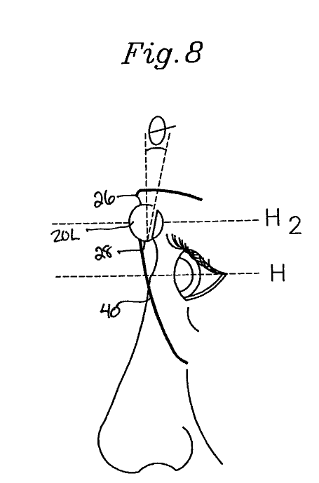

Full frame and rimless frames each have the upper lens rim 20. In the full-framed version shown in FIG. 8, the lens 40 sits in a groove in the upper lens rim 20. The lens rim 20 extends into side and lower lens rims 22, 24 to completely surround the peripheral edge of the lens 40.

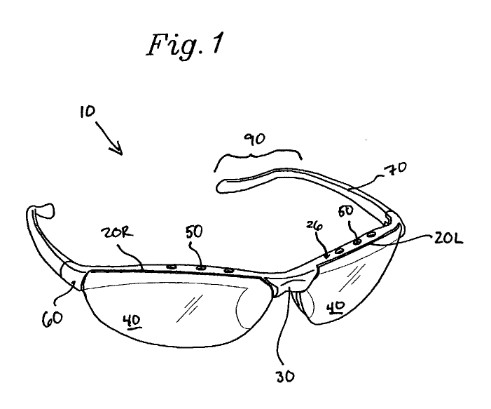

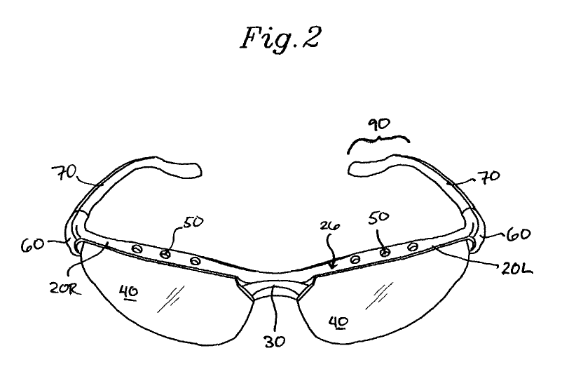

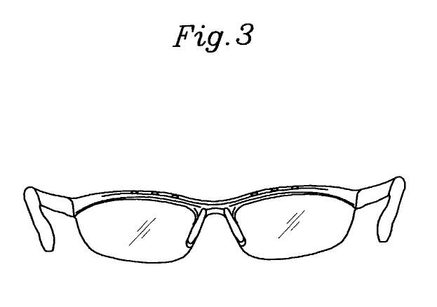

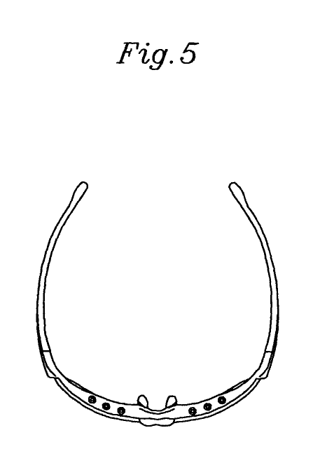

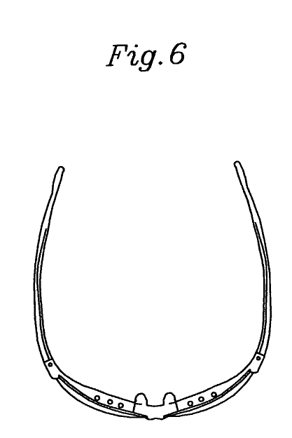

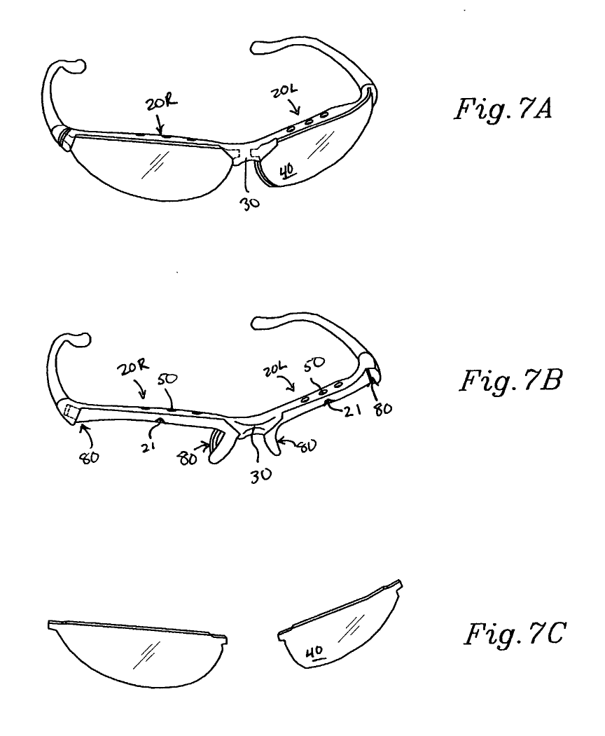

The rimless frames can be constructed in many different ways. As shown, the upper lens rim 20 is situated behind the lens. In the embodiment of FIGS. 1-7, the lenses are actually removable as shown in FIGS. 7A-7C, and interchangeable, as is known in the art. Many variations on this theme are possible, including an embodiment where the upper lens rim and the lens are integral (not shown). Regardless of the design, each upper lens rim 20 is fabricated specifically to reduce or eliminate fogging as described above.

The upper lens rim 20 defines at least an upper surface 26 and a lower surface 28 each of which extends rearwardly (toward the eye) from the lens position. The upper lens rim 20 defines a plurality of apertures 50 extending completely therethrough, from the upper surface 26 to the lower surface 28. The apertures 50 provide a passageway for air to flow behind the lens 40 when worn. The increased airflow behind the lens 40 helps reduce the temperature differential between the front and occular lens surfaces, and helps remove or reduce built up moisture behind the lens. The combined effect is reduced or eliminated fogging.

Although a plurality of apertures is preferred, a single, larger aperture may be used. The only limitation on the aperture or apertures is that is should allow adequate airflow without fatally affecting the strength of the frame. When only one aperture is defined it is preferably in the form of an elongated slot which allows airflow behind most of the lens surface. The shape of the apertures is not particularly limited, and may be round, as shown, or other geometrical shapes such as squares, rectangles, triangles, ovals, diamond, etc. The apertures could furthermore be crescent shaped, wave-shaped, slots or offset louvers. Again, any shape and size or combination thereof may be used and will ultimately be selected by determining the maximum volume of air a specific frame style can exchange without weakening the frame. Currently, the inventors prefer 1-20 apertures, although more could be used if needed. The Figs. Show a frame design with 3 round apertures for each lens.

Other designs have employed similar apertures to increase airflow. These designs, however, have employed horizontally oriented apertures. The inventive design employs substantially vertical apertures, with respect to a horizontal viewing angle H. The substantially vertical orientation of the apertures 50 reduces the amount of ambient light that reaches the eye. Horizontal openings are not used because they allow air and potentially distracting light a direct path toward the eye. By arranging the apertures 50 in a substantially vertical orientation, that is approximately at an angle θ of 70-90° from the horizontal viewing angle H, (repositioned as H₂ for reference), any ambient light that happens to enter the aperture 50 is directed away from the eye. Indeed, in preferred embodiments, the wearer cannot see light passing through the apertures even when the eyes are rolled upward toward the apertures 50. In a most preferred embodiment, the apertures 50 are angled such that the axis of the opening angles downwardly away from the eye, as shown in FIG. 8.

Referring now to the specific embodiment shown in FIGS. 1-7, a rimless variety of the eyeglasses are shown. The lenses 40, are preferably removable, and interchangeable between multiple sets of lenses of varying shape, color, or other feature. These glasses are characterized by the fact that the lens 40 sits in front of the upper lens rim 20.

The frame is made up of left and right upper lens rims 20L, 20R, interconnected by a bridge 30. The outboard ends of each upper lens rim defines a temple mount 60. The temple mount 60 provides a location to which a temple arm 70 is affixed. In the most preferred embodiments, the temple arm 70 is affixed to the temple mount for hinged rotation between storage and wearing positions. Although hinged temple arms are preferred, whether true hinges, living hinges, or otherwise, non-hinged frames may also be employed.

The upper lens rim 20 is provided with a flat front surface 21 for engaging the occular surface of the lens, an upper and a lower surface projecting rearwardly away from the front surface, and means 80 for accepting and retaining the lens. The upper rim 20 is also provided with a plurality of apertures 50 passing completely therethrough from the upper surface 26 to the lower surface 28. The axis of each aperture is established at a substantially vertical orientation based upon a horizontal line of sight. The angular displacement θ of the axis is approximately 70-90°. The size of the apertures 50 is selected to balance several properties desirable in the frame. The apertures must be of sufficient size to permit airflow which reduces or eliminates fogging under most conditions, while not being so large as to undesirably weaken the frame. Also, the apertures are not so large as to allow inordinate amounts of light to pass through them. This latter factor is also achieved through the angular displacement of the apertures.

During most activities, the line of sight is predominantly along the horizontal line H of sight depicted in FIG. 8. Of course, although this line of sight is dominant, variation from this horizontal line of sight occurs often during normal activities. Undistracted viewing along this line is crucial to the success of the glasses. The substantially vertical apertures do not detract from the visibility along this horizontal line. Any wind or light which passes through the apertures is directed away from the eye. Thus, the eye is subjected, at most, to indirect exposure to light and any element passing through the apertures. Even indirect exposure to light is further suppressed when the apertures are angled such that the lower end of the aperture is oriented in a direction facing away from the eye, towards the occular surface of the lens. Not only does this prevent direct exposure to the eye, but, also directs air currents directly onto the lens surface thereby increasing the cooling effect and reducing the temperature differential.

These same principles are used in the full-frame design. Importantly, neither design requires the lenses to be corrective or shades, optically clear and uncolored lenses may be used as well as corrective and shaded lenses.

To further improve performance of the glasses, the temple arm 70 is provided with a distal portion 90 adapted for engaging the mastoid process of the wearer. The design takes advantage of the bones of the human skull, and particularly the area of the mastoid bone which provides a natural area for grasping. Although this area is not very large or pronounced, it does provide an area for properly shaped materials to hold on to. The distal end 90 of each temple arm is bent in a subtle S-curve. Conventionally, the temple arm is either straight or curved downward behind the ear. Additional curving inward, to create tension is also common. The temple arm of the invention relies on both tension and the subtle S-curve to provide enhanced holding ability.

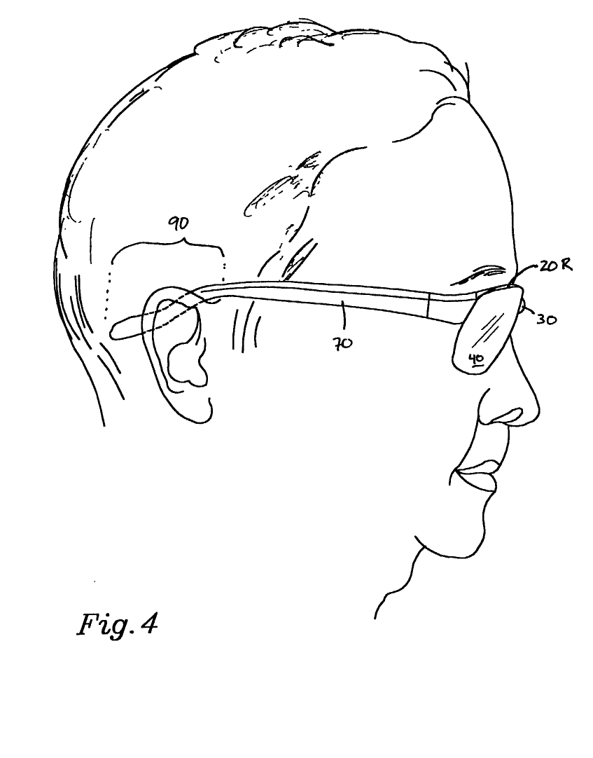

Referring now to FIG. 4 it is shown the temple arm 70 extends rearwardly from the temple in substantially a straight line to above the location of the ear. Once past the ear, the distal portion 90 of temple arm 70 curves downward to provide some wrapping around the ear. Then, the distal portion 90 curves back in the opposite direction to form a subtle S-shaped curve. This return curve corresponds roughly to the location of an indentation/projection in the mastoid. By engaging the skull's natural curves, a higher level of holding is achieved. This is a vital concern, especially for professional athletes who desire secure holding under many conditions, without the expense of added weight. Here, superior holding is achieved simply by modifying the curvature of the temple arm, and using no more material than traditional temple arms.

The above descriptions are illustrative in nature and are not intended in any way to limit the scope of the invention. Those skilled in the art will no doubt recognize obvious variants without departing from the spirit and scope of the invention as described in the claims.

1. A pair of eyeglasses comprising:
an upper lens rim having an upper surface and a lower surface, said upper lens rim adapted for holding a lens;
wherein said upper lens rim defines at least one substantially vertically arranged aperture passing completely therethrough from said upper surface to said lower surface for directing air behind the lens being held.

2. The eyeglasses of claim 1, wherein:
said at least one aperture forms an angle of approximately 70-90% from the horizontal.

3. The eyeglasses of claim 2, wherein:
said apertures are angled to deliver airflow to the ocular surface of said lens.

4. The eyeglasses of claim 1, wherein:
each upper lens rim is provided with 1-20 apertures.

5. The eyeglasses of claim 1, wherein:
each upper lens rim is provided with 3-5 apertures.

6. The eyeglasses of claim 1, wherein: said eyeglasses are a rimless design.

7. The eyeglasses of claim 1 wherein:
said eyeglasses are a full-framed design.

8. The eyeglasses of claim 1 wherein said at least one aperture has cross-sectional shape selected from the group consisting of circular, square, rectangular, triangular, oval, diamond-shaped, crescent shaped, wave-shaped, s-shaped, slot-shaped, and louvers.

9. A pair of eyeglasses comprising:
a right upper lens rim;
a left upper lens rim;
a right lens, having front and occular sides, supported by said right upper lens rim;
a left lens, having front and occular sides, supported by said left upper lens rim;
a bridge interconnecting said right upper lens rim with said left upper lens rim;
wherein each of said right upper lens rim and said left upper lens rim define a plurality of apertures, displaced 70-90° from a horizontal viewing angle passing through the approximate center of the lens, for allowing passage of air to cool the occular surface of the lens to limit fogging.

10. A pair of eyeglasses comprising:
a right upper lens rim;
a left upper lens rim;
a right lens, having front and occular sides, supported by said right upper lens rim;
a left lens, having front and occular sides, supported by said left upper lens rim;
a bridge interconnecting said right upper lens rim with said left upper lens rim;
wherein each of said right upper lens rim and said left upper lens rim define a plurality of apertures, displaced 70-90° from a horizontal viewing angle passing through the approximate center of the lens, for allowing passage of air to cool the occular surface of the lens to limit fogging.
a right temple, at an outboard side of said right upper lens rim;
a right temple arm hingedly affixed to said right temple, and having a distal end extending in a subtle S-shape for engaging the mastoid of the wearer;
a left temple, at an outboard side of said left upper lens rim;
a left temple arm hingedly affixed to said left temple, and having a distal end extending in a subtle S-shape for engaging the mastoid of the wearer.
